(19) United States
(12) Patent Application Publication
(10) Pub. No.: US 2014/0216210 A1
(43) Pub. Date: Aug. 7, 2014

(54) STRIKING DEVICE WITH SLIDING WEIGHT FOR INCREASING IMPACT FORCE

(71) Applicant: Timothy J. NEAR, Concord, NH (US)

(72) Inventor: Timothy J. NEAR, Concord, NH (US)

(21) Appl. No.: 13/759,308

(22) Filed: Feb. 5, 2013

(51) Int. Cl. B25D 1/00; B25D 1/02

(52) U.S. Cl. CPC B25D 1/00; B25D 1/02
USPC 81/25; 81/20; 29/434

(57) ABSTRACT

A striking device comprising a striking head, an elongate handle comprising a first end and an opposed second end. The striking head is affixed to the first end while the second end has a hand grip which facilitates gripping of the handle by an operator of the striking device. The handle accommodates a sliding weight which is movable, due to a swinging motion of the striking device, from the first end of the handle toward the second end of the handle to increase an impact force of the striking head as the striking head strikes an object to be struck.

### FIELD OF THE INVENTION

The present invention relates generally to striking devices and more specifically relates to striking device incorporating a sliding weight which is movable, by centrifugal force, so as to increase a velocity of the striking device and thereby increase a collision force between a striking head of the striking device and the object to be struck.

### BACKGROUND OF THE INVENTION

A number of striking devices are known from the prior art. Such know striking devices typically have a head, comprising a fixed weight located at a striking end thereof. That is, the weight of the head of the striking device remains constant as the striking device is utilized to strike a desired object. Depending on the type of striking device, the weight of the head can be anywhere between a few ounces to many pounds. Since a majority of the weight, of such currently known striking devices, is typically fixedly located at the head of such striking devices, it take much effort to swing such currently known striking devices and an operator, of such currently known striking devices, generally becomes easily fatigued when using such currently known striking devices over an extended period of time.

Since the weight distribution of the striking device does not change during the swinging motion of the prior art striking devices, the moment of inertia of the known striking devices remain constant over the entire swing arc. Because a majority of the weight of the known striking devices is located at, or closely adjacent the striking head, the associated effort which is generally required to swing the known striking devices is quite large.

### SUMMARY OF THE INVENTION

Wherefore, it is an object of the present invention to overcome the above mentioned shortcomings and drawbacks associated with the currently known prior art striking devices.

An object of the present invention is to provide a striking device that is easier to swing than conventional fixed weight striking devices. The striking device has a weight that slides along a portion of the length of a handle as the striking device is utilized. At the beginning of a swing, the weight of the striking device is located adjacent the hand of an operator while, at the end of the swing, i.e., when the striking device impacts the object to be struck, the weight of the striking device is located at an opposite end of the striking device. The weight is accommodated within the striking device so that the shift in weight reduces the effort needed to operate the striking device while, at the same time, increases the collision force between the striking device and the object to be struck.

A further object of the present invention is to provide a striking device having a weight that slides along the length of the handle away from the hand of the operator using the striking device to the opposite end of the striking device as the striking device is swung. The shift in weight of the striking device enables the person to swing the striking device at a greater angular velocity in comparison to known fixed weight striking devices of the prior art.

Another object is to provide a striking device having a weight that slides along the length of the striking device such that the shift in weight of the striking device facilitates an increase in angular acceleration of the striking device when the striking device is swung.

Another object of the invention is to provide a striking device that has interchangeable sliding weights, striking heads and/or handles that are suitable for different tasks (e.g., framing vs. finish carpentry) to optimize use and operation of the striking device.

The invention generally relates to a striking device which includes handle, which may comprise a frame, to which a striking head is either fixedly attached or form integrally therewith. At least a portion of the handle/frame and the striking head are hollow and form an elongate longitudinal channel. A sliding weight is located within the handle/frame and is slidable along the elongate longitudinal channel between a position that is remote from the head to a position within or located adjacent to the striking head. A low friction slide tube typically extends along the channel and supports and permits the weight to slid between the opposed ends of the elongate longitudinal channel. The low friction material functions to reduce friction between the sliding weight and the slide tube and thereby encouraging and promote sliding movement of the sliding weight.

The present invention also relates to a striking device comprising: a striking head, an elongate handle comprising a first end and an opposed second end, the striking head being affixed to the first end while the second end having a hand grip which facilitates gripping of the handle by an operator of the striking device, and the handle accommodating a sliding weight which is movable, due to a swinging motion of the striking device, from the second end of the handle toward the first end of the handle to increase an impact force of the striking head as the striking head strikes an object to be struck.

The present invention also relates to a method of increasing an impact force of a striking head as the striking head strikes an object to be struck, the method comprising the steps of: providing a striking head; affixing a first end of an elongate handle to the striking head; providing a hand grip, which facilitates gripping of the handle by an operator of the striking device, adjacent a second end of the handle; and accommodating a sliding weight via the handle so that the sliding weight is movable, due to a swinging motion of the striking device, from the second end of the handle toward the first end of the handle to increase the impact force of the striking head as the striking head strikes the object to be struck.

Other objects and advantages of the present invention will become obvious and apparent to the reader and it is intended that these objects and advantages are also within the spirit and scope of the present invention. Although embodiments of the invention will be described in relation to the accompanying drawings, it should be recognized that the drawings are for illustrative purposes only, and that changes and modifications may be made in the illustrated specific constructions and described within the scope of this application.

### BRIEF DESCRIPTION OF THE DRAWINGS

FIG. 1 is a diagrammatic perspective view of one embodiment of the striking device according to the present invention;

FIG. 2 is a diagrammatic right side elevation view of the striking device of FIG. 1;

FIG. 2A is a diagrammatic cross sectional side view of the striking device of FIG. 2;

FIG. 3 is a diagrammatic exploded perspective view of the striking device of FIG. 1;

FIG. 4 is a flowchart illustrating the overall operation of the striking device according to the present invention;

FIG. 5A is a diagrammatic illustration showing an initial striking position of striking device as well as an initial striking position of the sliding weight according to the present invention;

FIG. 5B is a diagrammatic illustration showing an intermediate striking position of striking device as well as an intermediate striking position of the sliding weight according to the present invention;

FIG. 5C is a diagrammatic illustration showing a final striking position of striking device as well as a final striking position of the sliding weight according to the present invention;

FIG. 6 is a diagrammatic perspective view of a second embodiment of the striking device according to the present invention;

FIG. 7 is a right side elevational view of the striking device according of FIG. 6;

FIG. 8 is a diagrammatic cross sectional side view of the striking device of FIG. 6;

FIG. 8A is a diagrammatic exploded perspective view of the striking device of FIG. 6;

FIG. 9 is a diagrammatic front elevational view of FIG. 6;

FIG. 10 is a diagrammatic view of yet another embodiment of the striking device according to the present invention;

FIG. 11 is a diagrammatic view of still another embodiment of the striking device according to the present invention;

FIG. 12 is a right side elevational view of an ax forming the striking device;

FIG. 13 is a diagrammatic cross sectional side view of the ax of FIG. 12;

FIG. 14 is a right side elevational view of a sledgehammer forming the striking device; and

FIG. 15 is a diagrammatic cross sectional side view of the sledgehammer of FIG. 14.

### DETAILED DESCRIPTION OF THE INVENTION

The present invention will be understood by reference to the following detailed description, which should be read in conjunction with the appended drawings. It is to be appreciated that the following detailed description of various embodiments is by way of example only and is not meant or intended to limit, in any way, the scope of the present invention.

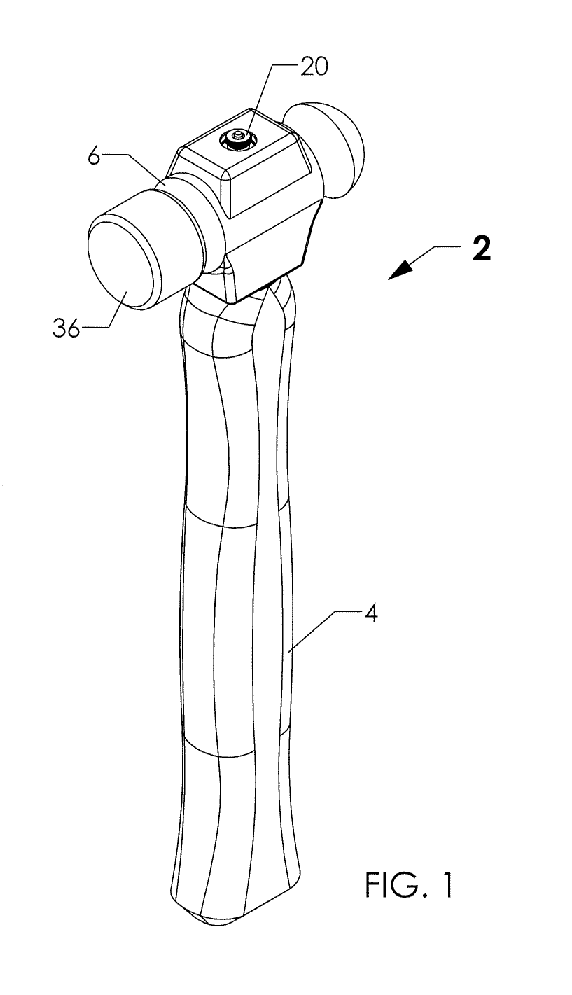

Turning now to FIGS. 1-3, a brief description concerning the various components of a first embodiment of the present invention will now be briefly discussed. As shown in this embodiment, the striking device 2 generally comprises an elongate handle 4, typically a removable/interchangeable partially lightened or hollow striking head 6, a tensioning shaft 8 having a threaded first end and a head 22 at a second end thereof, a low friction slide tube 10 engages with the tensioning shaft 8 which supports a sliding weight 12, a pair of opposed impact absorption mechanisms, such as springs 16 and/or impact absorption bumpers or elements 18, and typically a first retaining element 20, which matingly engages with the first end of the tensioning shaft 8. It is to be appreciated that the tensioning shaft 8 may be threaded at both opposed ends thereof and, in such instance, the head 22 would be replaced by a retaining element 22.

The handle 4 generally comprises an elongated structure or member that defines a longitudinal central axis and supports the striking head 6 at a first end thereof while the opposite second end of the handle 4 generally comprises a conventional hand grip 24, either formed as part of the handle 4 or a separate component secured to the second end of the handle 4, which facilitates grasping of the striking device 2 by an operator. It is to be appreciated that the striking device 2 may either have a permanently affixed striking head 6 or the striking device 2 may have interchangeable striking heads 6 (e.g., a framing head, a finish carpentry head, etc.) in order to optimize use and operation of the striking device 2.

Typically, a smaller dimensioned neck 26 is located adjacent the first end of the handle 4 and a shoulder 28 separates the neck 26 from a remainder of the handle 4. The neck 26 is intimately received within a mating blind head cavity or opening 30 provided in a central region of the striking head 6 to facilitate attachment, either permanent or releasable, of the first end of the handle 4 with the striking head 6 in a conventional manner, e.g., by a mating first threaded retaining element 20, for example. The shoulder 28 and the blind head cavity or opening 30 both assist with preventing further insertion or movement of the striking head 6 toward the second end of the handle 4 while the first retaining element facilitates a secure releasable attachment of the striking head 6 with the handle 4.

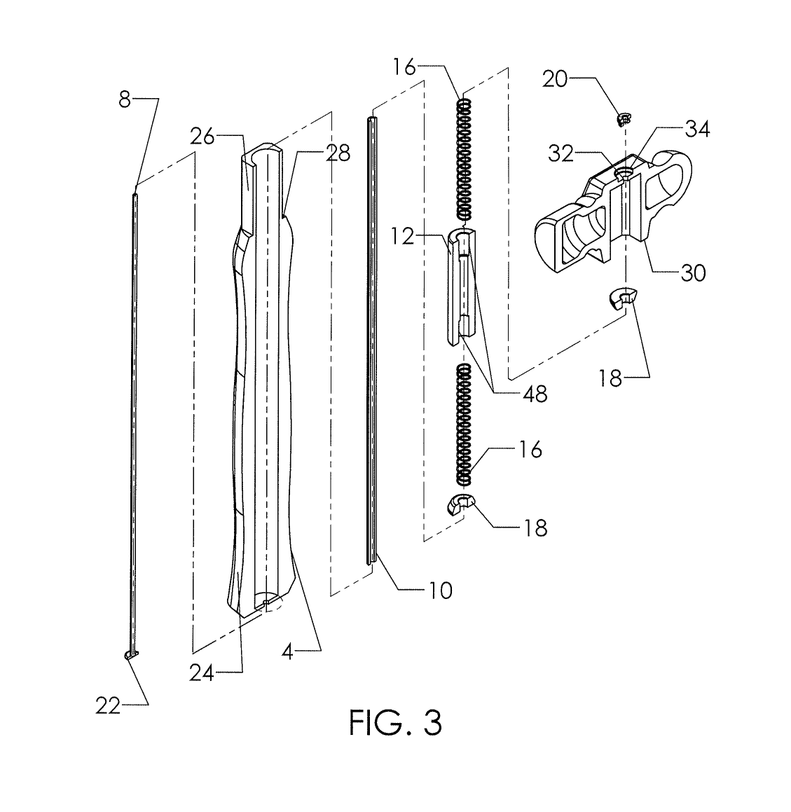

The neck 26 of the handle 4 is configured or shaped to intimately and closely mate with the mating blind head cavity or opening 30 provided in the striking head 6. As shown in FIG. 3, the neck 26 of the handle 4 generally has a rectangular cross section while the striking head 6 has a slightly smaller but corresponding rectangular blind head cavity or opening 30. It is to appreciated, however, that the striking head 6 may have essentially any other desired cross-sectional shape as long as the blind head cavity or opening 30 of the striking head 6 has a mating corresponding cross-sectional shape. The important aspect of the engagement between the striking head 6 and the handle 4 is that the striking head 6 and the handle 4 be securely attached to one another so as to avoid or prevent relative movement between the handle 4 and the striking head 6 as the striking head 6 impacts a desired object to be struck O during use.

As show in FIG. 3, an exterior surface of the striking head 6, which closes the blind head cavity or opening 30, is provided with a head through bore 32 and an associated head counterbore 34. The first end of the threaded tensioning shaft 8 passes through the head through bore 32 and the first retaining element 20 threadedly engages with the exposed portion of the tensioning shaft 8 so as to bias the striking head 6 toward the neck 26 of the handle 4 and generally against the shoulder 28 to provide a secure attachment between the handle 4 and the striking head 6.

A leading striking face 36 of the striking head 6 generally comprises a weighted, solid flat surface which is designed to provide the desired impact to the object to be struck O. It is to be appreciated that the leading striking face 36 of the striking head 6 may have a variety of different surface shapes, surface profiles, surface features, etc. For example, the striking face 36 may have the shape of a framing hammer, a ball peen hammer, and ax, a sledgehammer, a tack hammer, a masons hammer, etc., while the opposite trailing end of the striking head 6 may have another different surface shape, surface profile, surface feature, etc. It is to be appreciated that the features to be located at each opposed end of the striking head 6 are quite numerous, conventional and well know in the art and thus are not discussed in any further detail. However, it is noted that the striking head 6 of the depicted embodiment of FIGS. 1-3 comprises a first feature located at a leading end of the striking head 6, namely, typically a planar striking surface but other non-planar configurations or surfaces are also possible, and a second feature located at a trailing end of the striking head 6, namely, a semispherical striking surface. As a result, the striking device 2 is quite similar to a conventional ball peen hammer.

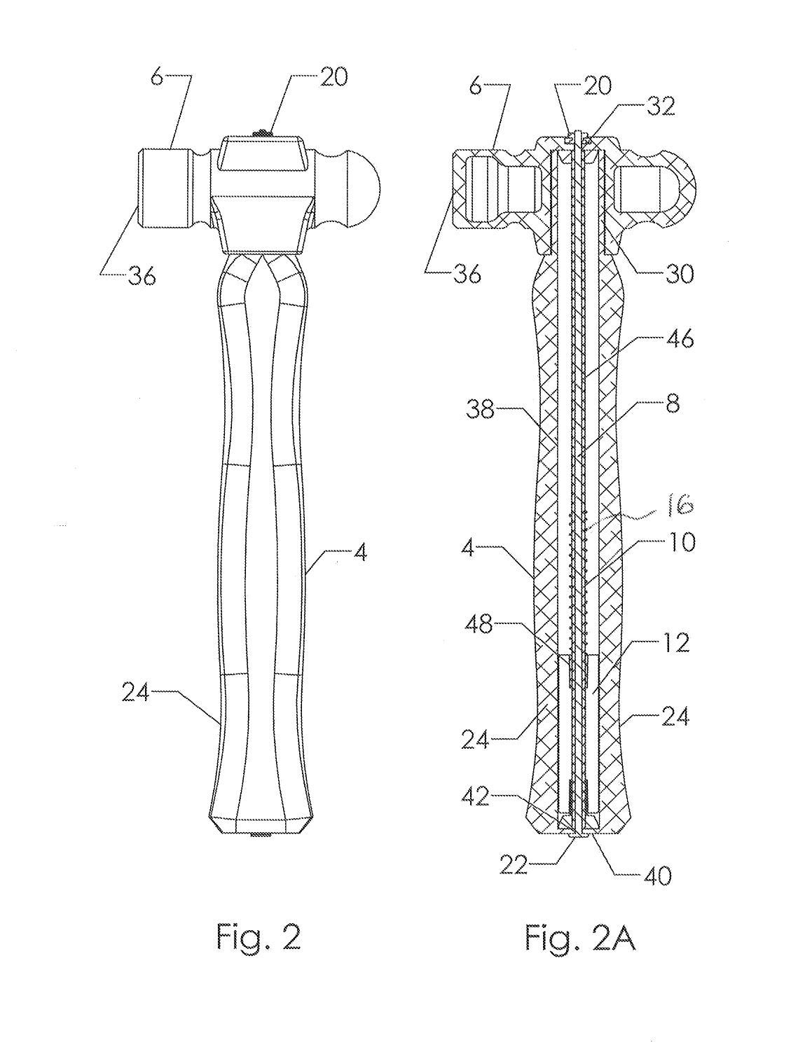

As more generally shown in FIG. 2A, the striking head 6, according to the present invention, is preferably at least partially hollow so as to reduce an overall weight of the striking head 6. Due to such at least partially hollow striking head 6, the overall weight of the striking head 6 is thereby significantly reduced and thus an operator can more easily pick up and manipulate the striking head 6 with less effort over a prolonged period of time. Further benefits of a partially hollow striking head 6, which has a reduced weight in comparison to other prior art striking heads, will be discussed in further detail below.

As generally shown in FIGS. 1-3, the exterior surface of the second end of handle 4 is configured and contoured so as to be comfortably gasped and held by a hand of a person utilizing the striking device 2 (i.e., an operator) and thereby form the hand grip 24 of the handle 4. If desired, a rubber grip, or some other conventional hand grip may be secured to the second end of the handle 4 to facilitate comfortably gripping of the striking device 2 by the operator. As the design of such comfortable hand grips is generally well known in the art and does not, per se, comprise an essential part of the present invention, a further detailed discussion concerning the same is not provided. However, it is important to note that at least an elongate section of the handle 4 must be shaped or configured so as to allow an elongate longitudinal channel 38 to extend axially therealong as will be described in further detail below.

As best shown in FIG. 2A, the handle 4 of the striking device 2 comprises the elongate longitudinal channel 38 that is open at a first end thereof. The second end of the elongate longitudinal channel 38 is generally closed by a blind channel surface 40 and a channel through bore 42 extends completely through the blind channel surface 40 of the handle 4. The elongate longitudinal channel 38 has a substantially uniform cross section along the entire length of the elongate longitudinal channel 38. The exterior surface of the handle 4, which forms the blind channel surface 40 may be, if desired, provided with a second counter bore, which receives a head/second threaded fastener 22, and the second counter bore, if provided, would be concentric with the channel through bore 42. The tensioning shaft 8 is sized to pass through the channel through bore 42 and while the second counter bore, if present, receives and engages with the head/second threaded fastener 22 to secure the tensioning shaft 8 to the second end of the handle 4.

As noted above, both opposed ends of the tensioning shaft 8 are threaded while a central portion of the tensioning shaft 8 has a generally smooth cylindrical surface 46 which facilitates sliding movement therealong. The tensioning shaft 8, along with the first retaining element 20 and/or heads/second retaining element 22, respectively engaged with one another to releasably and securely fasten the striking head 6 and the handle 4 with one another when the neck 26 of the striking head 6 is suitably received within the blind head cavity or opening 30 of the striking head 6. In addition, the tensioning shaft 8 acts as a support for various elements which will be discussed below in further detail.

As noted above, the tensioning shaft 8 is securely retained within the elongate longitudinal channel 38, e.g., space from the inwardly facing surface or surfaces which defines the elongate longitudinal channel 38, and the hollow low friction slide tube 10 is supported by the tensioning shaft 8 and sandwiched between opposed ends of the elongate longitudinal channel 38. An inner dimension of the low friction tube 10 is larger than (e.g., by many thousands of an inch or so) an outer diameter of the tensioning shaft 8 while the inner diameter of a central portion of the sliding weight 12 is slightly larger than (e.g., by a few thousands of an inch or so) the outer dimension of the central smooth cylindrical surface 46 of the low friction slide tube 10 so that there is only a small or minimal lateral clearance between the inwardly facing surface of the sliding weight 12 and the exterior smooth cylindrical surface 46 of the low friction slide tube 10. Such lateral clearance facilitates sliding movement of the sliding weight 12 along the low friction slide tube 10. As a result of such a configuration, the tensioning shaft 8 maintains both the low friction slide tube 10 and the sliding weight 12 generally in a centered location within the elongate longitudinal channel 38. Preferably, at least the exterior surface of the low friction slide tube 10 is manufactured from a low friction material, such as nylon or Teflon® for example. If desired or necessary, the inwardly facing surface of the sliding weight may also be coated with a low friction material, such as nylon or Teflon® for example.

As noted above, the exterior surface of the slide tube 10 supports the sliding weight 12, which may be generally cylindrical or rectangular, for example, so that the sliding weight 12 is also substantially centered and coaxial with the elongate longitudinal channel 38 so as to avoid contacting the inwardly facing surface of the elongate longitudinal channel 38 during sliding movement.

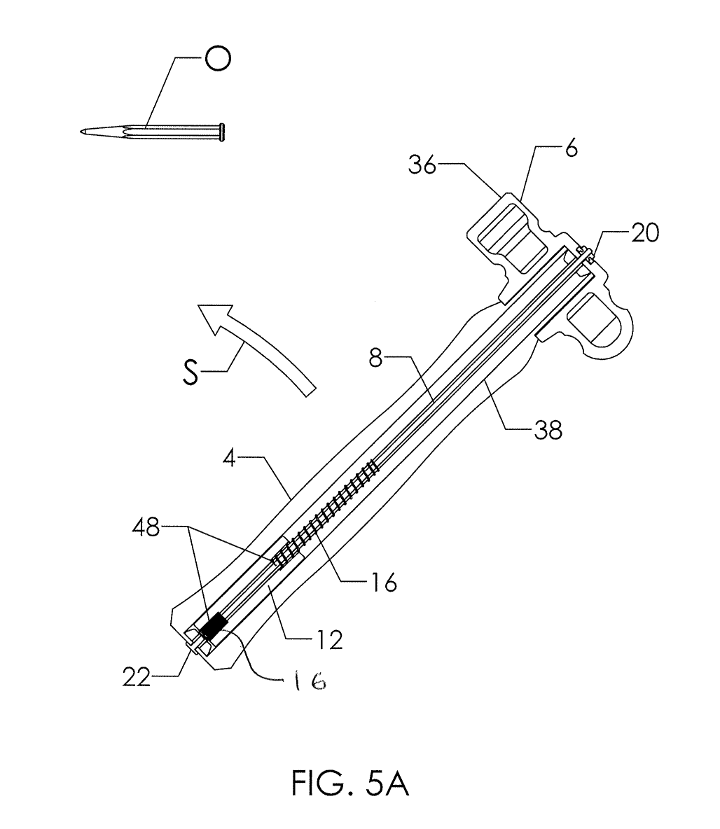

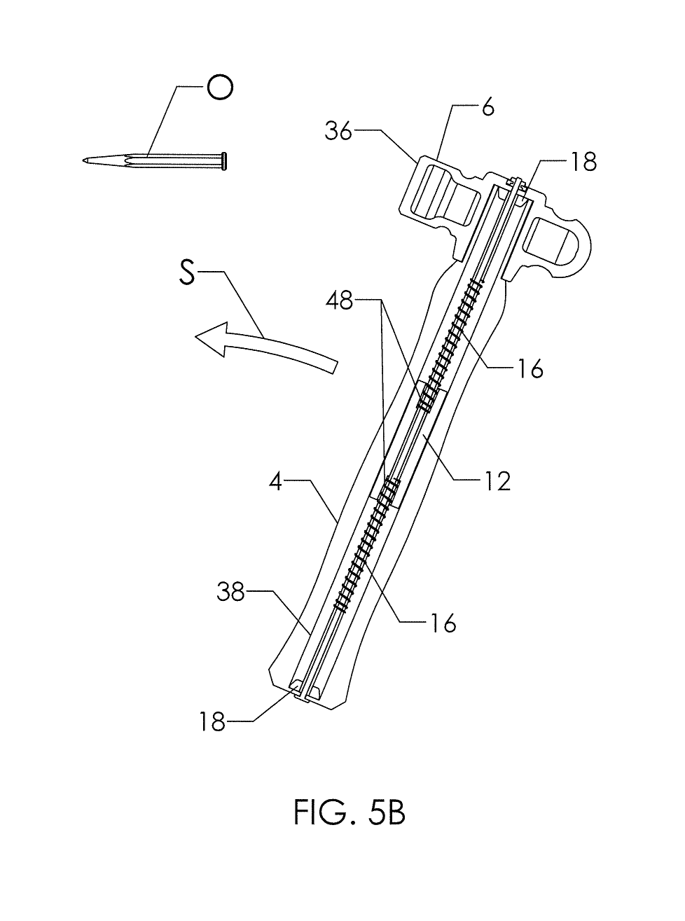

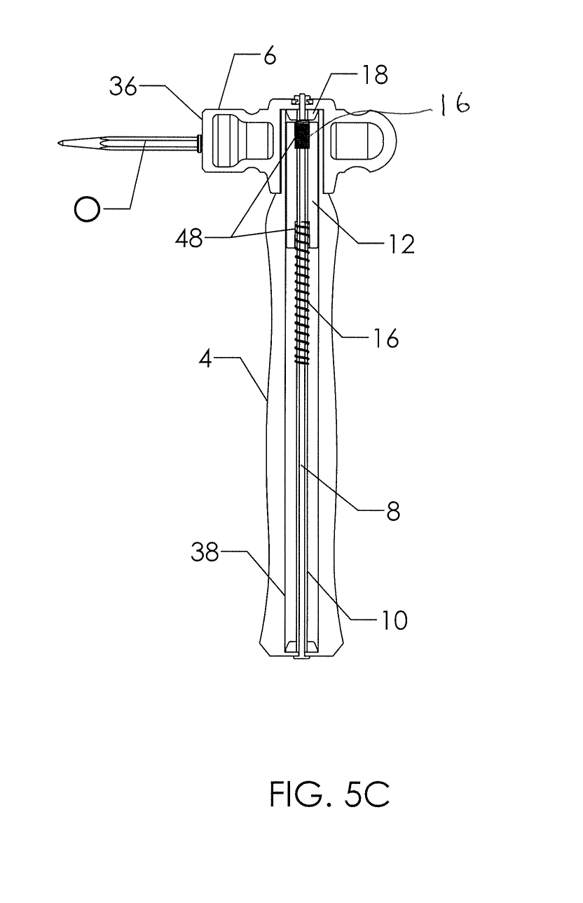

The axial length of the sliding weight 12 is generally about 2-10 times a total length of the elongate longitudinal channel 38, more preferably the sliding weight 12 has an axial length which is less than about 3-8 times the total length of the elongate longitudinal channel 38, and most preferably the sliding weight 12 has an axial length which is less than about 3.5-6 times the total length of the elongate longitudinal channel 38. Due to such arrangement, the sliding weight 12 is able to slide axially to and fro along the central, unthreaded smooth cylindrical surface 46 of the low friction slide tube 10 and within the elongate longitudinal channel 38 of the frame of the striking device 2. Such movement allows the sliding weight 12 to be located adjacent the second end of the handle 4, e.g., substantially centered with respect to the palm of the operator, when the striking device 2 is in the position shown in FIG. 5A, and the sliding weight 12 can subsequently move to a position closely adjacent the striking head 6, either at impact or at an instance immediately before impact with the object be struck O.

The exterior dimension of the sliding weight 12 is sized such that the exterior surface of the sliding weight 12 is continuously maintained clear of the inwardly facing surface of the elongate longitudinal channel 38 so as to avoid contact therewith as the sliding weight 12 slides to and fro within the elongate longitudinal channel 38, as will be discussed below in further detail. Due to such clearance, only a minimal amount of force or energy is typically required in order to induce sliding movement of the sliding weight 12 along the slide tube 10, e.g., along the tensioning shaft 8. The sliding weight 12 can have a total weight which is typically between 2 and 24 ounces and more typically between 6 and 12 ounces.

Each opposed end of the tensioning shaft 8 typically supports one or more springs 16, or possibly one or more other dampening bumpers or elements 18, which is arranged to rapidly decelerate and stop further travel of the sliding weight 12 within the elongate longitudinal channel 38 and along the tensioning shaft 8. It is to be appreciated that such spring(s) 16 may be affixed to opposite ends of the sliding weight 12, affixed to opposite axial ends of the elongate longitudinal channel 38 or supported on the tensioning shaft 8 between the sliding weight 12 and opposed ends of the elongate longitudinal channel 38 (e.g., the springs 16 may be free to axially slide along the tensioning shaft 8 between the sliding weight 12 and the respective opposed ends of the elongate longitudinal channel 38).

Each spring 16 generally assists with absorbing energy and rapidly decelerating and thus minimizing an impact force of the sliding weight 12 against each opposed end of the elongate longitudinal channel 38 of the handle 4 as the sliding weight 12 slides to and fro along the tensioning shaft 8 and within the elongate longitudinal channel 38. In the event that a further reduction of the impact force of the sliding weight 12 is desired, one or more impact dampening bumpers or elements 18 can be secured at each opposed end of the tensioning shaft 8, at remote ends of the elongate longitudinal channel 38, in order to enhance absorbing energy and decelerating the sliding weight 12.

As shown in FIGS. 2A, 3, 5A-5C and 12-15, each opposed end of the sliding weight 12 has a spring counter bore 48 formed therein and such spring counter bore 48 facilitates receiving a portion of the respective spring 16 as the sliding weight 12 slides toward either the first end or the second end of the elongate longitudinal channel 38. During such sliding motion, the associated spring 16 is compressed by the sliding weight 12 and accommodated within the spring counter bore 48 as the sliding weight 12 is decelerated by the spring 16. Such arrangement also still permits the leading surface of the sliding weight 12 to abut against the dampening element 18 and thereby interrupt further sliding motion of the sliding weight 12 within the elongate longitudinal channel 38. As shown in FIG. 3 for example, each of the springs 16 and each of the spring counter bores 48 generally have an equal axial length to one another. It is to be appreciated that the overall axial length of each one of the springs 16 and/or the spring counter bores 48 can vary so that the length of one spring 16 and/or spring counter bore 48 is longer than the length of the other spring 16 and/or spring counter bore 48.

It is desirable, as the sliding weight 12 reaches the first end of the elongate longitudinal channel 38 located adjacent the striking head 6, for the sliding weight 12 to be snugly received by the first end of the elongate longitudinal channel 38 so as to minimize any radial movement of the sliding weight 12 upon impact of the striking head 6 with the object to be struck O at the moment that the striking head 6 impacts with the object to be struck O. In the event that the sliding weight 12 is not radially confined within the elongate longitudinal channel 38, at the precise moment that the striking head 6 impacts with the object to be struck O, the sliding weight 12 tends to continue moving along the swing path of the striking device 2, even after impact with the object to be struck O, and such continued motion of the sliding weight 12 induces a bending force on the tensioning shaft 8. In order to minimize this, it is desirable to receive the sliding weight 12 within a confined recess which closely mirrors the exterior shape of the sliding weight 12 so that, at the time the object to be struck O, is actually being struck by the striking device 2, the sliding weight 12 is snugly confined within and by the elongate longitudinal channel 38 and such confinement avoids or minimizes inducing any significant bending force on the tensioning shaft 8.

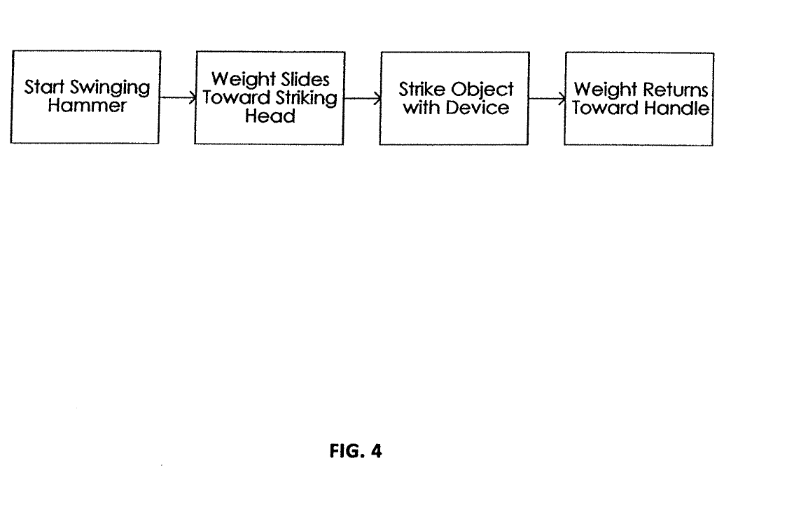

The use and operation of the striking device 2, according to the present invention, will now be described with reference to FIGS. 4 and 5A, 5B and 5C. It is to be understood that the use and operation of all of the embodiments of the present invention which are described herein, are generally similar to FIGS. 5A, 5B and 5C.

By way of example, operation of the striking device 2 will now be described in relation to driving a nail (e.g., the object to be struck O) into a desired surface, but it is to be understood that the improved striking device 2, according to the present invention, can be utilized for a variety of different purposes and applications as well. During use, the operator grabs the hand grip 24 of the handle 4, in a conventional manner, and then positions the striking device 2 in an initial striking position, as generally shown by FIG. 5A. As shown by this initial starting position of the striking device 2, i.e., prior to or at the start of an impact swinging motion indicated by arrow S, the sliding weight 12 is located at or adjacent the second end of the elongate longitudinal channel 38 closely adjacent and next to the hand grip 24 and furthest away from the striking head 6. That is, the sliding weight 12 is generally in abutting engagement with the second spring 16 and/or dampening element 18 located adjacent the second end of the elongate longitudinal channel 38. It is possible that either, or both, the second spring 16 or the dampening element 18 may be slightly or partially compressed when the striking device 2 is in the position shown in FIG. 5A. Due to such location of the sliding weight 12 and further due to lighter weight of the striking head 6 (e.g., the striking head being partially hollow), a larger portion of the overall weight of the striking device 2 is located adjacent the hand grip 24 of the handle 4 which is being grasped by the operator of the striking device 2.

It is to be appreciated that, in this initial position shown in FIG. 5A, a greater portion of the overall weight of the striking device 2, in comparison to a conventional prior art hammer, is located at or near a second end of the striking device 2, which generally comprises a pivoted end of the striking device 2, so that the moment of inertia, of the striking device 2, is much lower in comparison to known striking devices in which a greater percentage of the weight is permanently located at, or near, the striking head 6. As such, the energy needed to initiate a swinging motion of the striking device 2, according to the present invention into an impact position, is greatly reduced while, at the same time, it is easy to swing the striking device 2 with a greater angular acceleration. In other words, since much of the weight of the striking device 2 is located at, or near, the hand of the operator, the striking device 2 can generally be swung faster and with less effort by the operator.

As shown in FIG. 5B, the striking device 2 is swung by the operator in the direction of arrow S and is now located in an intermediate striking position. Due to the inertia acting on the sliding weight 12, the sliding weight 12 commences sliding movement along the tensioning shaft 8, away from the second end and toward the first end of the elongate longitudinal channel 38 and the striking head 6. It is to be appreciated that any possible minor frictional force(s), acting on the sliding weight 12 and tending to retain the sliding weigh 12 in the initial position shown in FIG. 5A, are easily be overcome by the swinging motion S created by the operator. In addition, in the event that the second spring 16 and/or dampening element 18 were partially compressed in the initial position of the striking device 2 of FIG. 5A, such force can assist the sliding weight 12 with overcoming any such frictional forces and propel the sliding weight 12 toward the first end of the elongate longitudinal channel 38 and the striking head 6 during the swing motion S of the striking device 2. As the sliding weight 12 slides toward the striking head 6, the moment of inertia of the striking device 2 increases together with the kinetic energy thereof due to the swinging motion S of the striking device 2. In other words, as the striking device 2 is swung in the direction of arrow S, the movement of the sliding weight 12 toward the striking head 6 increases the overall impact or striking force of the striking head 6.

The sliding weight 12 continues traveling along the tensioning shaft 8 and preferably reaches the first end of the elongate longitudinal channel 38 at precisely the same time that the striking device 2 reaches its striking position, i.e., at the precise point in time when the striking head 6 impacts the nail, as shown in FIG. 5C, or at an instance a split second before that point in time. Once the sliding weight 12 is located at the first end of the elongate longitudinal channel 38, the moment of inertia of the striking device 2 is now at a maximum. Due to this maximum moment of inertia of the striking device 2 and the generally increased angular velocity of the striking device 2, the kinetic energy of the striking device 2 is also now at a maximum. In other words, with the sliding weight 12 being located at, or closely adjacent, the striking head 6 and due to the tendency of the operator to increase his/her swinging speed, due to the reduced overall weight of the striking head 6 at the beginning of the swinging motion S, the striking force of the striking head 6 is at its maximum with minimal effort exerted by the operator.

With known striking devices, because more of the overall weight of the striking device 2 is continuously located at or adjacent the striking head 6, the angular acceleration and angular speed of the striking device 2 tends to be somewhat lower in comparison to the angular acceleration and angular speed of the inventive striking device 2 according to the present invention. As a result, the kinetic energy or striking force of the striking head 6 of known prior art striking devices also tend to be lower in comparison. In addition, an operator using such known prior art striking device tends to expend more energy in swinging such known prior art striking device in comparison with swinging the inventive striking device 2 according to the present invention.

As generally shown in FIG. 5C, namely, the striking position of the striking device 2, the sliding weight 12 at least partially compresses the first spring 16 and/or the first dampening element 18 located at or adjacent the first end of the elongate longitudinal channel 38. The first spring 16 and/or the dampening element 18 facilitate adsorption of the axial sliding movement of the sliding weight 12 and thereby prevent the sliding weight 12 from impacting against the second end of the elongate longitudinal channel 38 and possibly causing displacement of the striking device 2 with respect to the object to be struck O, e.g., the nail. As noted above, the one or more impact adsorption bumpers or elements 18, located at the ends of the elongate longitudinal channel 38, aid with adsorbing the axial force of the sliding weight 12 and storing energy to assist with returning the sliding weight 12 back to the opposite end of the elongate longitudinal channel 38.

Following impact between the striking face 36 of the striking head 6 and the object to be struck O, e.g., the nail, as generally shown in FIG. 5C, the operator will then return the striking device 2 back through the intermediate position, shown in FIG. 5B, and to the initial striking position shown generally FIG. 5A so that the striking device 2 is then repositioned for another swing. As a result of such return motion, the sliding weight 12 will generally slide or return back toward its initial starting position located closely adjacent the second end of the elongate longitudinal channel 38. As noted above, it is to be appreciated that the first spring 16 and/or first dampening element 18 can store energy and subsequently release such stored energy which assists with returning the sliding weight 12 back to its initial striking position generally shown in FIG. 5A.

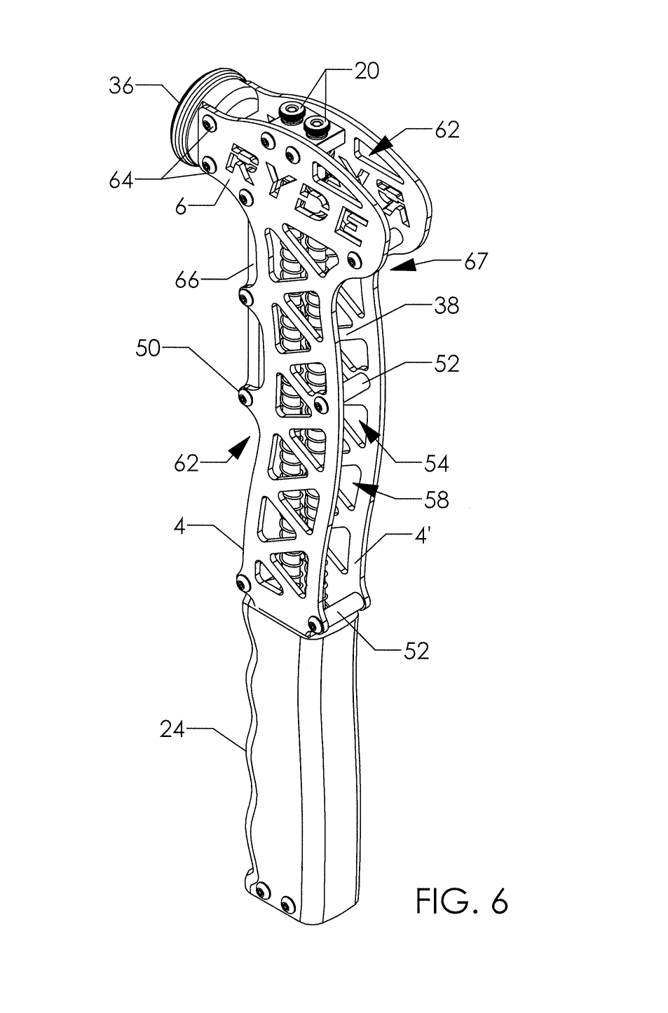

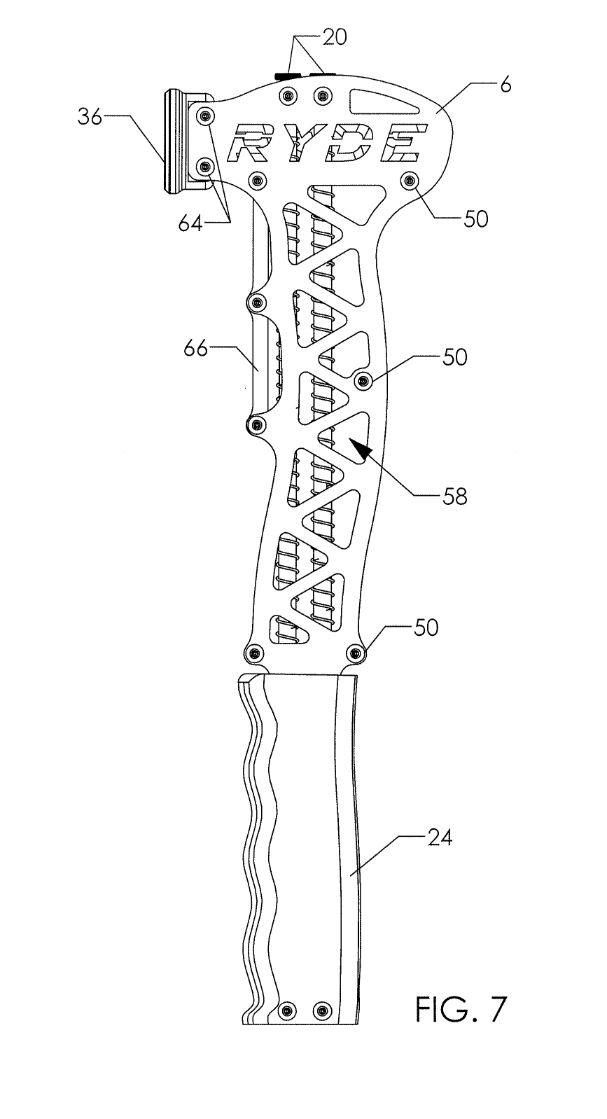

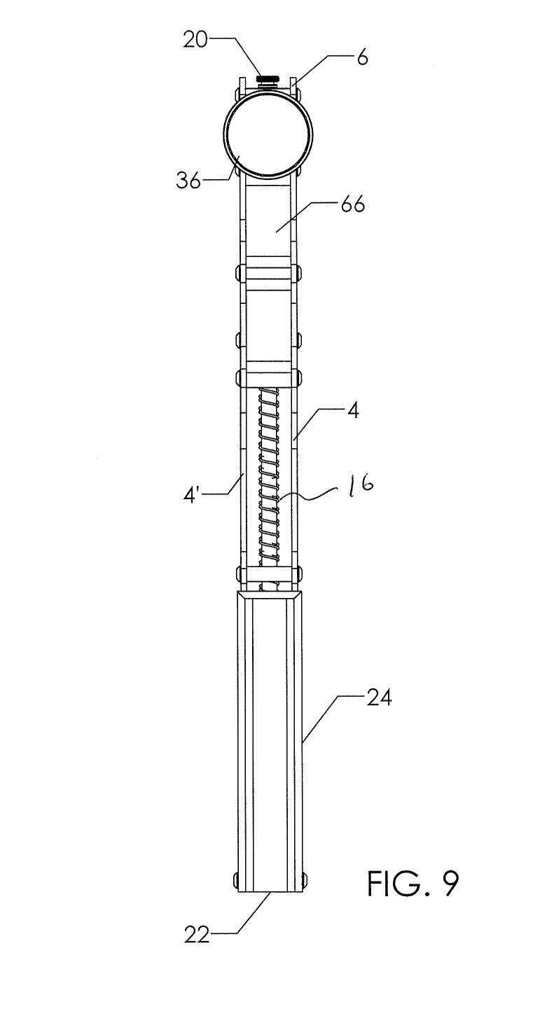

Turning now to FIGS. 6-9, a description concerning a second embodiment of the present invention as well as the difference between that embodiment and the previous embodiment will now be briefly discussed. As can be seen in this second embodiment, the striking device 2 comprises a handle which having a frame, removable/interchangeable striking face(s) 36, a sliding weight 12, a pair of parallel tension shafts 8 and a pair of low friction slide tubes 10. 10′.

The handle 4, according to this embodiment, generally comprises a pair of first and second spaced apart planar metallic plates 4′, 4″. A plurality of fasteners 50, i.e., screws, nuts, bolts and rivets, along with an associated spacers 52, such as a hollow cylindrical tube, fasten the first and second spaced apart plates 4′, 4″ to one another. It is to be appreciated that the number and/or spacing of the plurality of fasteners 50 and associated spacers 52 can vary, from application to application, but are generally sufficient to rigidly couple the first and second plates 4′, 4″ with one another. It is desirable that both the fasteners 50 and the spacers 52 be located about the periphery of the first and the second plates 4′, 4″ so as to leave a substantially open interior space 54 within the frame, that extends from the first end to the second end of to the handle 4 completely clear and unobstructed.

Each one of the spacers 52 has an identical length so that the spacers 52 facilitate spacing the first and second plates 4′, 4″ a constant and uniform distance away from one another. Each of the first and second plates 4′, 4″ have aligned mating through holes 56 which each receive an associated one of the fasteners 50 and facilitate coupling of the first and second plates 4′, 4″ with one another with an associated spacer 52. Opposed ends of each spacer 52 abut against inwardly facing surfaces of the first and second plates 4′, 4″ which face toward and define the interior space 54 while the associated fastener 50 passes through the interior hollow space of the associated spacer 52 so as to captively retain the spacer 52. When the first and second plates 4′, 4″ are coupled to one another, they form a rigid frame.

According to this embodiment, the striking head 6 is also integrally formed as part of the first and second plates 4′, 4″. That is, the first and second plates 4′, 4″ are also shaped and contoured so as to form both the handle 4 as well as the leading and the trailing ends of the striking head 6. As discussed above, a desired, preferably replaceable, striking face 36 is then affixed or secured to the leading end of the striking head 6.

The first and second plates 4′, 4″ are typically manufactured from a planar, durable material such as sheet metal, e.g., having a thickness of between 0.020 inches and 0.150 inches, more preferably the thickness of the first and second plates is between 0.060 inches and 0.125 inches and most preferably the thickness of the first and second plates is about 0.094 inches. Generally, the first and second plates 4′, 4″ and the plurality of fasteners/spaces 50, 52 form a rigid frame which is designed to resist stresses placed thereon by repeatedly striking of a variety of different surfaces or objects to be struck O. The overall weight of the frame can be reduced, if desired, by cutting or forming one or more cutouts and/or other apertures 58 in one or both of the first and the plates 4′, 4″. It is to be appreciated that the number, shape and arrangement of the cutouts and/or other apertures 58 can vary depending on the desired final weight and strength of the frame. It should further be appreciated that the manner by which the first and the second plates 4′, 4″ are coupled to and/or spaced from one another is not critical except that the frame should be sufficiently lightweight as well as be sufficiently strong and durable.

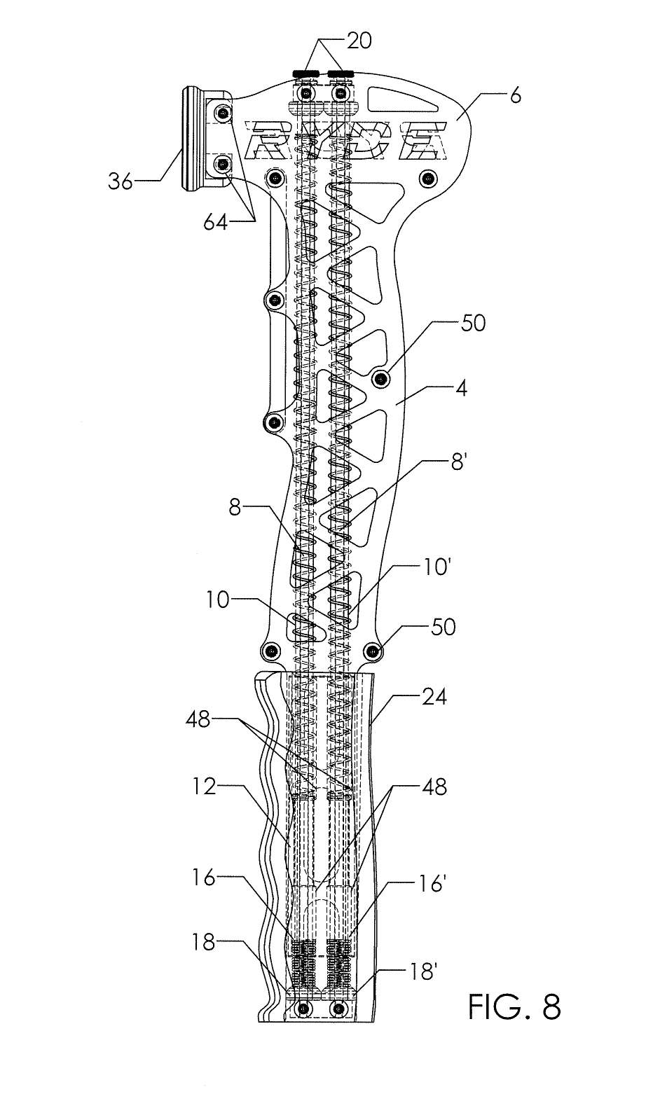

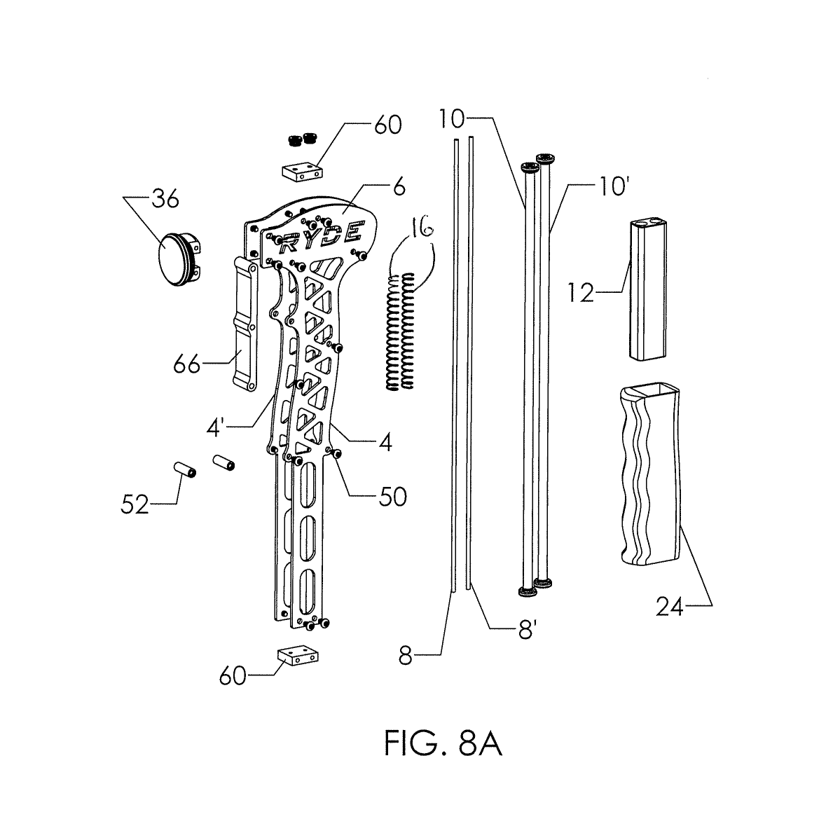

A hand grip 24 is fixed or otherwise secured to a second end of the handle 4 of the frame and has an exterior profile that is generally configured and/or contoured so as to be comfortably gasped by and held within the hand of the person utilizing the striking device 2. As the configuration of comfortable hand grips 24 is generally known in the art, a further detail description concerning the same will not be provided. The second end of the handle 4, which accommodates the hand grip 24, is generally hollow and forms part of the interior space 54 and the elongate longitudinal channel 38 that receives the sliding weight 12. As shown in FIGS. 8 and 8A, the hand grip 24 surrounds the handle 4 of the frame. The handle grip is fixed to the first and second plates 4′, 4″ of the handle 4 via fasteners 50 and associated spacers.

First and second elongate tensioning shafts 8, 8′ extend along the interior space 54 of the elongate longitudinal channel 38 and at opposed ends of the first and the second elongate tensioning shafts 8, 8′ pass through mating through bores 32, 42 formed in a respective surface 60 which is located at the first and second ends of the handle 4 and integral with one of the first and second plates 4′, 4″. The exterior of each respective surface 60 has an associated counterbore 34 formed therein for receiving either the first retaining element 20 or the head/second retaining element 22 as the elongate tensioning shafts 8, 8′ are secured in place. Prior to securing the elongate tensioning shafts 8, 8′ in place, the two spaced apart through bores of the sliding weight 12 matingly engage with a respective one of the first and second elongate tensioning shafts 8, 8′ and within the interior space 54 so as to be slidable along the elongate longitudinal channel 38.

Similar to the low friction slide tube 10 of the previous embodiment, the low friction slide tube 10, 10′ of this embodiment are hollow and made of a low friction material. The low friction slide tubes 10, 10′ extend coaxially to and with one of the tensioning shafts 8, 8′ such that the respective sliding weight 12 is respectively slidable along both of the low friction slide tubes 10, 10′. The slide tube 10 or 10′ and mating the tensioning shaft 8 or 8′ are dimensioned such that there is either a sufficient lateral clearance therebetween to insert the tensioning shaft 8 or 8′ through the center of the slide tube 10 or 10′. As a result of such configuration, the respective tensioning shaft 8 or 8′ and the low friction slide tube 10 or 10′ maintain alignment of associated the sliding weight 12 within the elongate longitudinal channel 38.

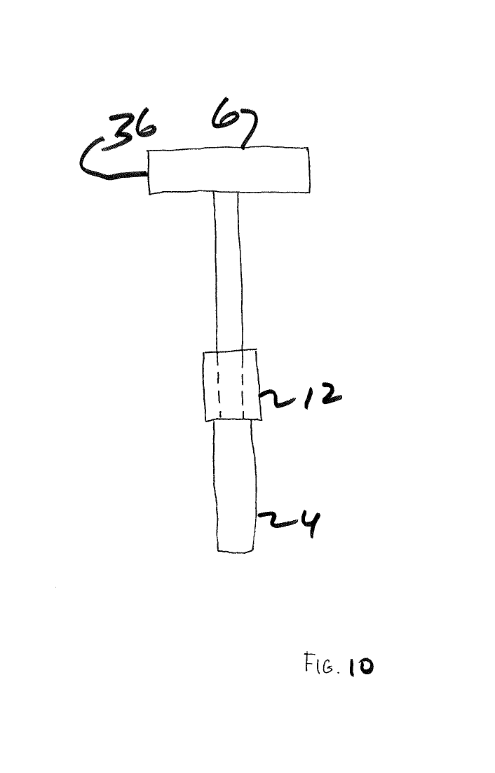

In the event that the elongate longitudinal channel 38 is generally a confined space, then it may be desirable for either the sliding weight 12, the opposed and walls of the elongate longitudinal channel 38 or possibly sidewalls defining the elongate longitudinal channel 38, to be provided with one or more air passages, air ducts or air vents 62 which allow air to flow either through the sliding weight 12 or into and out of the first and the second ends the elongate longitudinal channel as the sliding weight 12 moves to and fro (see FIG. 11). Such air passages, air ducts or air vents 62 prevent air from becoming trapped at either end of the elongate longitudinal channel 38 and thus avoid such air from becoming at least partially compressed. It is to be appreciated that any compressed air, which forms along either end of the elongate longitudinal channel 38, tends to slow, retard or otherwise inhibit the desired sliding movement of the sliding weight 12 from one end of the elongate longitudinal channel 38 to the other end.

The striking device 2, as illustrated in FIGS. 6-9, comprises a striking face 36. The striking face 36 is received by and secured to and between the frame plates at the leading end of the striking head 6. One or more fasteners 64 are utilized to secure the striking face 36 to the head of the frame so that the striking face 36 is detachable to facilitate replacement of the striking face 36, as desired or necessary. The ability to remove and replace the striking face 36 enables interchanging one striking face 36 with another such as when the striking device 2 will be utilized for two different purposes.

The striking device 2 further includes a sliding weight striking pad 66, e.g., typically manufactured from a polyoxymethylene, also known as acetal, polyacetal and polyformaldehyde, which is an engineering thermoplastic (such as Delrin® manufactured by E. I. du Pont de Nemours and Company) or some other low friction material, which can be secured at or adjacent the strike head of the handle 4. The sliding weight striking pad 66 is secured to the frame such that an inwardly facing surface of the sliding weight striking pad is aligned with and adjacent at least one of the low friction slide tubes 10, 10′. This arrangement of the sliding weight striking pad 66 in relation to the low friction slide tube 10, 10′ allows for the sliding weight 12 to slide to its end position, at the first end of the handle 4, where the sliding weight 12 is closely adjacent the sliding weight striking pad 66. The sliding weight striking pad 66 is used to transfer at least a portion of the kinetic energy of the sliding weight 12 to the striking device 2 as the striking face 36 impacts against the element to be struck O and thus minimizes the bending force which is transferred to the low friction slide tubes 10, 10′ and/or tensioning shafts 8, 8′.

Further it should be understood that the striking device 2 illustrated in FIGS. 6-9 can also include one or more springs 16 and/or impact adsorption bumpers or elements 18, as with the previous embodiment. In order to absorb the force of the sliding weight 12 upon impact, it is beneficial for the bumpers or elements 18 to be made of an elastic material.

As the elongate tensioning shafts 8, 8′ in the above embodiments can be removed from the frame by unscrewing and loosening the first retaining element 20 or the head/second retaining element 22, it is possible to disassemble the striking device 2 and exchange the sliding weight 12. In this manner, the striking device 2 can be modified by exchanging the sliding weight 12 and replacing it with either a sliding weight 12 that is lighter or heavier so as to either increase the overall weight of the striking device 2 or decrease the overall weight of the striking device 2.

As shown in FIG. 8, each opposed end of the sliding weight 12 has a pair of spring counter bores 48 and each such spring counter bore 48 facilitates receiving a portion of the respective spring 16 therein as the sliding weight 12 slides toward either the first end or the second end of the elongate longitudinal channel 38. During such sliding motion, the pair of associated springs 16 are compressed by the sliding weight 12 and accommodated within the respective spring counter bore 48 as the sliding weight 12 is decelerated by the springs 16. Such arrangement also still permits the leading surface of the sliding weight 12 to abut against the associated dampening elements 18 and interrupt further sliding motion of the sliding weight 12 within and along the elongate longitudinal channel 38. As shown in FIG. 8, the two springs 16, located between the first end of the elongate longitudinal channel 38 and the sliding weight 12, each have an equal axial length to one another but have a longer axial length (e.g., between about 2 to 5 time longer) than the axial length of the other two springs 16 located adjacent the second end of the elongate longitudinal channel 38. The pair of spring counter bores 48, formed in the first end of the sliding weight 12 are each equal to one another but are both longer than the axial length of the pair of spring counter bores 48 formed in the second end of the sliding weight 12. It is to be appreciated that the overall axial length of each one of the springs 16 and/or the spring counter bores 48 can vary so that the length of one spring 16 and/or spring counter bore 48 is longer than the length of the other spring 16 and/or spring counter bore 48.

Still another embodiment of the present invention, in one broad form, is diagrammatically illustrated in FIG. 10. According to this embodiment, the striking device 2 generally comprises a striking head 6 with a striking surface 36, a handle 4 extending from the striking head 6 and an external sliding weight 12 that is capable of sliding to and fro along an exterior portion of a longitudinal length of the handle 4.

Yet another broad embodiment of the present invention, is diagrammatically illustrated in FIG. 11. According to this embodiment, the striking device 2 generally comprises a striking head 6 with a striking surface 36, a handle 4 extending from the striking head 6 and an internal sliding weight 12 that is capable of sliding to and fro along within the elongate longitudinal channel formed within the handle 4. According to this embodiment, the exterior surface of the internal sliding weight 12 has a small sliding clearance with the inwardly facing surface of the elongate longitudinal channel 38. As a result, the tensioning shaft is not required in this embodiment. Moreover, this embodiment ensures that the sliding weight 12 is generally radially confined when the sliding weight 12 reaches the first end of the elongate longitudinal channel 38 and the striking device 2 impacts the object to be struck O. The sliding weight 12 and/or one or both of the opposed ends of the elongate longitudinal channel 38 typically have one or more air passages, air ducts or air vents 62 which allow air to flow into and out of the elongate longitudinal channel 38 and/or through the sliding weight 12 as the sliding weight 12 moves to and fro within the elongate longitudinal channel 38.

The striking device 2 may have different means for guiding the sliding weight 12 within the elongate longitudinal channel 38 including a series of rollers, or external cylindrical guides. The sliding weight 12 may possibly be slowed down in some other manner such as, for example, air controlled dampening or magnetic dampening.

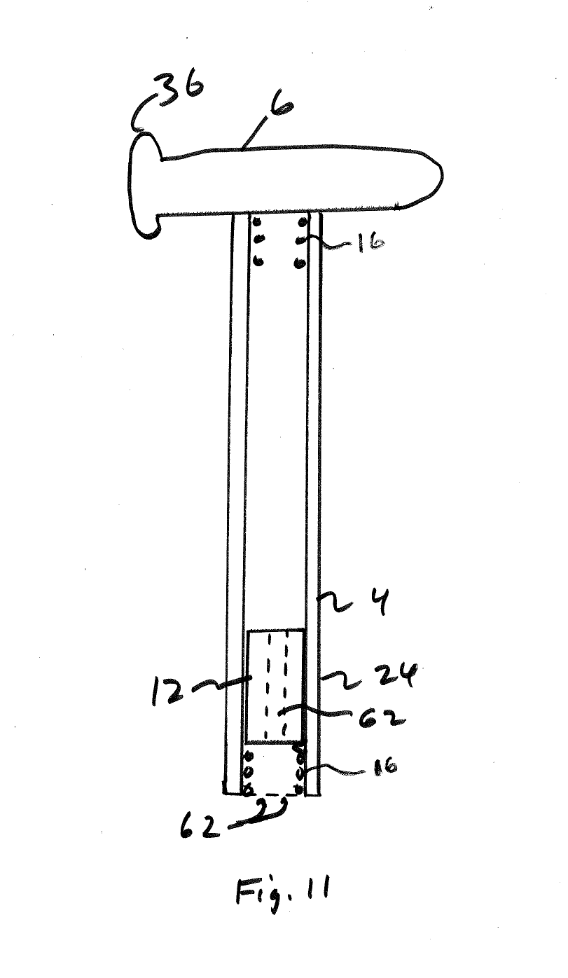

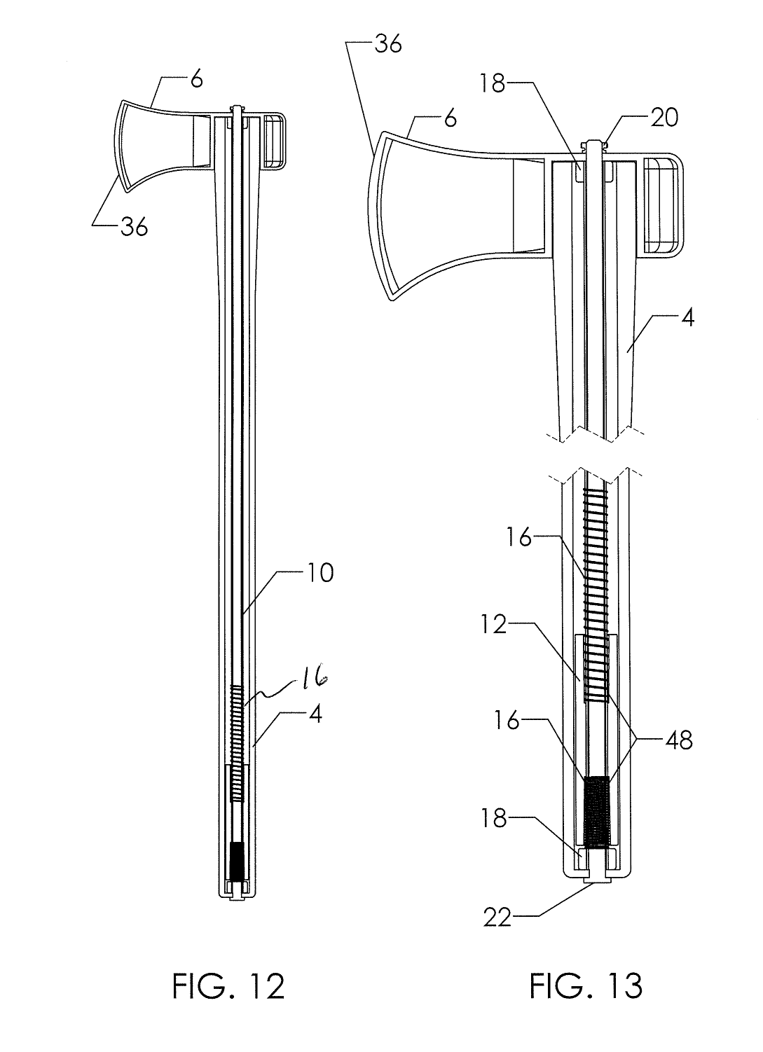

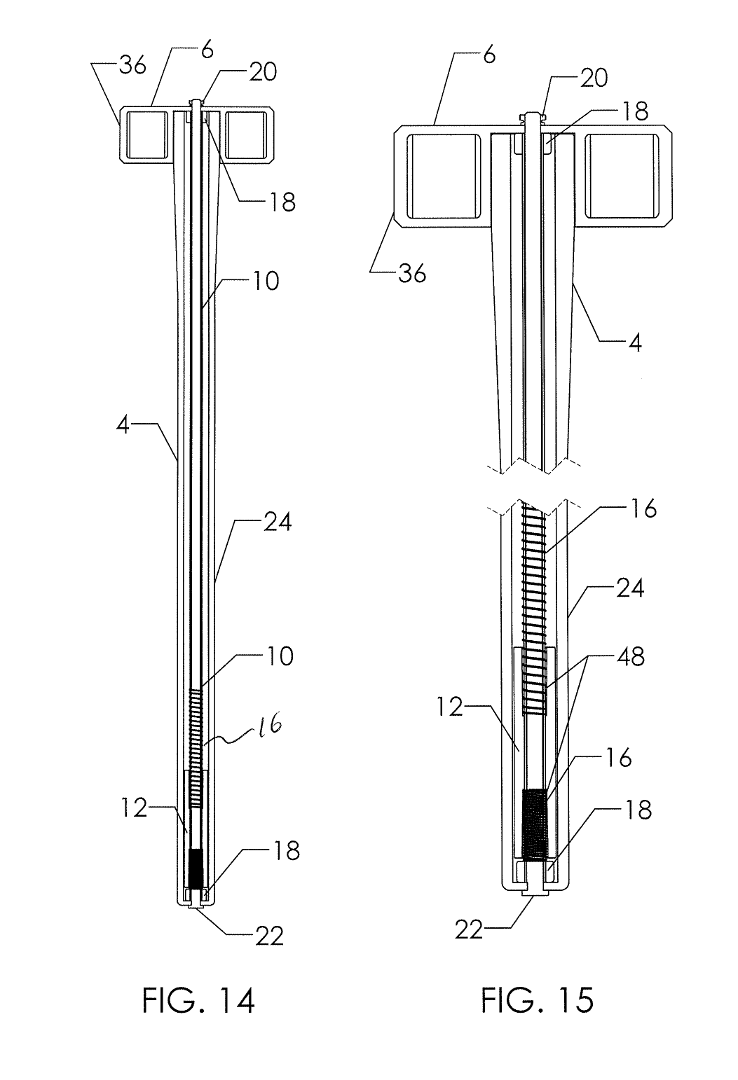

As indicated above, the design of the striking heads 6 and striking devices 2 can vary depending on a number of different factors, such as the intended function of the striking device/striking head as well as the ability and skill of the operator. It is conceivable that the striking devices 2 can be hand held tools such as hammers, mallets or sledges and each of these can have a variety of different striking heads 6 depending on the particular application or intended use, e.g., framing hammer and ball-peen hammer. The striking heads 6 can comprise different styles of cutting edges such as those utilized with axes, hatchets (as exemplified by FIGS. 12 and 13 for example), picks, or sledgehammers (as exemplified in FIGS. 14 and 15 for example). Further, it is conceivable that striking devices 2 can be incorporated into a variety of different sporting equipment such as, for example, a baseball bat, a golf club, a tennis racket, etc.

In the above description and appended drawings, it is to be appreciated that only the terms “consisting of” and “consisting only of” are to be construed in the limitative sense while of all other terms are to be construed as being open-ended and given the broadest possible meaning.

While various embodiments of the present invention have been described in detail, it is apparent that various modifications and alterations of those embodiments will occur to and be readily apparent those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

Wherefore, I claim:

1. A striking device comprising:
a striking head,
an elongate handle comprising a first end and an opposed second end, the striking head being affixed to the first end while the second end having a hand grip which facilitates gripping of the handle by an operator of the striking device, and
the handle accommodating a sliding weight which is movable, due to a swinging motion of the striking device, from the second end of the handle toward the first end of the handle to increase an impact force of the striking head as the striking head strikes an object to be struck.

2. The striking device according to claim 1, wherein the handle accommodates a tensioning shaft and a first end of the tensioning shaft is secured adjacent the first end of the handle while a second end of the tensioning shaft is secured adjacent the second end of the handle, and the sliding weight is slidable to and fro along a central portion of the tensioning shaft.

3. The striking device according to claim 1, wherein the sliding weight slide along a slid tube and at least a portion of one of the slide tube and the sliding weight is manufactured from a low friction material.

4. The striking device according to claim 1, wherein the handle comprises an elongated structure which defines a longitudinal axis and the striking head is releasably affixed to the handle to facilitate changing the striking head.

5. The striking device according to claim 1, wherein the first end of the handle has a neck and a shoulder separates the neck from a remainder of the handle, and the striking head has a mating blind head cavity which engages with the neck to facilitate attachment of the first end of the handle to the striking head.

6. The striking device according to claim 5, wherein the neck generally has a rectangular cross section while the striking head has a slightly smaller but corresponding rectangular blind head cavity.

7. The striking device according to claim 1, wherein a surface of the striking head forms the blind head cavity is provided with a head through bore, and an end the threaded tensioning shaft passes therethrough and a first retaining element threadedly engages with an exposed portion of the tensioning shaft so as to bias the striking head into engagement with the handle and provide a secure attachment between the handle and the striking head.

8. The striking device according to claim 1, wherein a leading striking face of the striking head comprises a solid flat surface which is designed to provide the desired impact to the object to be struck.

9. The striking device according to claim 1, wherein the striking head is at least partially hollow so as to reduce an overall weight of the striking head and facilitate easier manipulation and swinging of the striking device.

10. The striking device according to claim 1, wherein the handle comprises an elongate longitudinal channel that is open at a first end thereof, an opposed second end of the elongate longitudinal channel is closed by a blind channel cavity and a channel through bore extends completely through a surface closing the blind channel cavity, and the tensioning shaft passes through the channel through bore, and the elongate longitudinal channel has a substantially uniform cross sectional along an entire length thereof.

11. The striking device according to claim 1, wherein an internal dimension of the sliding weight is slightly larger than an outer dimension of a cylindrical surface of the slide tube supported by the tensioning shaft so as to facilitate sliding movement of the sliding weight along the slide tube and maintains the sliding weight in a centered location within the elongate longitudinal channel, and a central portion of the slide tube has a generally smooth cylindrical surface which facilitates sliding movement of the sliding weight therealong.

12. The striking device according to claim 1, wherein the sliding weight has a weight which is typically between 2 and 24 ounces and has an axial length which is between 2-10 times a total axial length of the elongate longitudinal channel.

13. The striking device according to claim 1, wherein at least one of a spring and a dampening element is located within elongate longitudinal channel to facilitate deceleration and thus minimize an impact force of the sliding weight against an end of the elongate longitudinal channel.

14. The striking device according to claim 1, wherein the handle comprises a pair of spaced apart first and second plates, and a plurality of fasteners and associated spacers 52 facilitate attachment of the first and second plates with one another, and a hand grip is secured to the second and the handle facilitate manipulation of the striking device by an operator.

15. The striking device according to claim 1, wherein the handle accommodates first and second tensioning shafts within an elongate longitudinal channel formed between the first and second plates, and each of the first and second tensioning shaft support a respective sliding weight.

16. The striking device according to claim 14, wherein the elongate longitudinal channel communicates with at least one at least one air passage which permits air to flow in and out of the elongate longitudinal channel and thus avoid air from becoming at least partially compressed within the elongate longitudinal channel.

17. The striking device according to claim 1, wherein the first and second plates form the handle as well as leading and the trailing ends of the striking head, and a replaceable striking face is secured to the leading end of the striking head.

18. A striking device comprising:
an elongate handle comprising a first end and an opposed second end;
a striking head being formed as part of the first end of the handle while the second end of the handle having a hand grip which facilitates gripping of the handle by an operator of the striking device;
a striking surface being supported at a leading end of the striking head of the striking device;
the handle comprising a pair of first and second spaced apart planar plates which fastened to one another by a plurality of fasteners, and the first and the second plates defining an the elongate longitudinal channel therebetween;
the handle accommodating a sliding weight which is movable along the elongate longitudinal channel, due to a swinging motion of the striking device, from adjacent the second end of the handle toward the first end of the handle to increase an impact force of the striking head as the striking head strikes an object to be struck.

19. The striking device according to claim 18, wherein the handle accommodates a pair of spaced apart tensioning shafts and a first end of each of the pair of tensioning shafts is secured adjacent the first end of the handle while a second end of each of the tensioning shafts is secured adjacent the second end of the handle, and the sliding weight is slidable to and fro along a central portion of the pair of tensioning shafts; and
each of the pair of spaced apart tensioning shafts supports a slid tube, and the sliding weight slide along each of the slid tube and at least a portion of one of the slide tube and the sliding weight is manufactured from a low friction material.

20. A method of increasing an impact force of a striking head as the striking head strikes an object to be struck, the method comprising the steps of:
providing a striking head;
affixing a first end of an elongate handle to the striking head;
providing a hand grip, which facilitates gripping of the handle by an operator of the striking device, adjacent a second end of the handle, and
accommodating a sliding weight via the handle so that the sliding weight is movable, due to a swinging motion of the striking device, from the second end of the handle toward the first end of the handle to increase the impact force of the striking head as the striking head strikes the object to be struck.
